(19) United States
(12) Patent Application Publication
(10) Pub. No.: US 2002/0032028 A1
(43) Pub. Date: Mar. 14, 2002

(54) Method and apparatus for automatic collection and loading of configuration data into equipment by installers using wireless technology

(76) Inventor: Arthur Kaupe, Chevy Chase, MD (US)

Correspondence Address: Hughes Electronics Corporation, Patent Docket Administration, P.O. Box 956, Bldg. 1, Mail Stop A109, El Segundo, CA, 90245-0956, US

(21) Appl. No.: 09/825,634

(22) Filed: Apr. 4, 2001

Related U.S. Application Data
(60) Provisional application No. 60/216,097, filed on Jul. 6, 2000.

(51) Int. Cl. H04Q 7/20

(52) U.S. Cl. 455/427; 455/11.1; 455/556

(57) ABSTRACT

A method and apparatus allowing an installer to configure and commission a large number of satellite terminals in the field without requiring the installer to either handle papers or to manually enter alphanumeric data into a computer, thus reducing the chances of human error. The installer uses a portable processing device capable of wireless communication to download work orders from a network service provider, obtain identification codes from satellite terminal components, obtain geographic location (e.g., via GPS), load work order and location to satellite terminal, upload configuration data from the satellite terminal, point a dish to optimally receive signals while viewing pointing information generated by the portable processing device, commission the satellite terminal within the satellite communication network, and upload completed work orders and commissioning data from the satellite terminal to the network service provider.

The present invention claims benefit under 35 U.S.C. 119(e) of a U.S. provisional application of Arthur Kaupe entitled “Automatic Collection and Loading of Configuration Data Into Equipment by Installers Using Wireless Technology”, Ser. No. 60/216,097, filed Jul. 6, 2000, the entire contents of which is incorporated herein by reference.

### BACKGROUND OF THE INVENTION

1. Field of the Invention

The present invention relates to a method and apparatus for configuring and commissioning electronic equipment via wireless communications so as not to require manual entry of alphanumeric data by an installer. More particularly, the present invention relates to an apparatus and method to configure and bring into commission electronic equipment such as a plurality of satellite terminals using a hand-held computer such as a personal digital assistant (PDA) which is portable and can be taken by an installer to the respective sites of the electronic equipment, where the installer does not need to manually enter alphanumeric data to complete configuration and commissioning.

2. Description of the Related Art

In a conventional network, configuration and commissioning of electronic equipment such as satellite terminals require the installer to receive work orders, which can be electronic and/or paper documents, and to read installation information provided on the work order documents (e.g., address or location of installation, serial numbers of equipment to be installed, time of installation, identification of the satellite with which the terminal is to be in communication, type of service, such as basic, premium, content preferences, and so on), and to enter information (e.g., time and data of completion of commissioning) on sheets of paper in writing or electronically enter information via a computer keypad, touch screen, mouse, or similar input device. The installer visits the sites of the equipment requiring configuration and commissioning, manually performs the required configuration, and reports the results to a network service provider by returning the completed work order documents. The network service provider is generally operable to manage the equipment such as satellite terminals in a satellite communication or broadcast network. This approach generally requires the installer to carry paper documents and/or a hand-held computer with which the installer enters alphanumeric data on a keypad or other input device and reads alphanumeric data from a screen. Entering alphanumeric data and writing on papers presents the problem of increasing the possibility of errors in the commissioning process and also hinders the ability of the installer to perform a time efficient installation and commission of a large number of satellite terminals.

A need therefore exists for a method and apparatus that accomplishes configuration and commissioning of electronic equipment such as satellite terminals without requiring the installer to enter alphanumeric data onto a keypad or to require the installer to handle a large number of papers and to manually enter information on these papers into a computerized system.

### SUMMARY OF THE INVENTION

It is therefore an object of the present invention to provide an improved method and apparatus for configuring and commissioning electronic equipment that overcomes the above deficiencies.

It is also an object of the present invention to provide a method and an apparatus for configuring electronic equipment such as satellite terminals in the field using wireless communications so as not to require alphanumeric keyed or handwritten inputs by the installer.

It is still another object of the present invention to provide an installer with a personal digital assistant (PDA) or other hand-held or portable computer that is capable of wireless communication to enable an installer to configure geographically dispersed electronic equipment such as satellite terminals that does not require the installer to have to electronically enter alphanumeric data or physically manage papers (e.g., sort, file and otherwise complete or write information onto the papers) associated with the installation and commissioning processes.

It is still another object of the present invention to provide an installer with a personal digital assistant (PDA) or other hand-held or portable computer that is capable of wireless communication with the network service provider, the indoor unit of a satellite terminal, the outdoor unit of the satellite terminal and a global positioning satellite system to enable an installer to bring into commission electronic equipment such as satellite terminals located in the field.

These and other objects are substantially achieved by using a hand-held or portable computer such as a PDA capable of wireless communication to enable an installer to first download work orders from a network service provider. The installer carries the computer into the field where electronic equipment (e.g., satellite terminals) is located and requires initial installation or reconfiguration or otherwise commissioning. The installer reads automatically a bar code, a radio frequency identification tag or other identification data from the electronic equipment using the computer. The installer then proceeds to obtain his position from a global positioning system (GPS) using the computer. The installer transmits the work order and the position information from the computer to the electronic equipment. The installer receives, via the computer, adjustments (e.g., polarization and antenna pointing information) that are preferably generated by the equipment and that need to be implemented by the electronic equipment. The installer makes these adjustments while consulting the display on the computer, for example. The computer communicates with the electronic equipment and can indicate to the installer when the adjustments are complete via real-time feedback data from the equipment. The installer again points the computer at the electronic equipment to initiate commissioning and subsequently upload commission data to the computer. The installer then proceeds to install or reconfigure and commission other electronic equipment located at different locations. Finally, the installer, using the computer, uploads confirmation information and/or commissioning data to the network service provider, thereby completing the installation and commissioning of electronic equipment at a number of locations without the necessity of having to manually enter alphanumeric data into any piece of equipment, including the computer, and without the necessity of having to handle paper documents or write information onto these pieces of paper.

### BRIEF DESCRIPTION OF THE DRAWINGS

These and other objects, advantages and novel features of the invention will be more readily appreciated from the following detailed description when read in conjunction with the accompanying drawings, in which:

FIG. 1 illustrates a network service provider in communication with one or more PDAs in accordance with an embodiment of the present invention;

FIG. 2 is a schematic block diagram of a PDA configured in accordance with an embodiment of the present invention;

FIG. 3 illustrates the PDA scanning information from an indoor unit of a satellite terminal in accordance with an embodiment of the present invention;

FIG. 4 illustrates the PDA scanning information from an outdoor unit of a satellite terminal in accordance with an embodiment of the present invention;

FIG. 5 illustrates the PDA obtaining positioning information from satellites in a GPS constellation according to the principles of the present invention; and

FIG. 6 illustrates an installer manually pointing the satellite terminal antenna dish, while looking at the screen of the PDA, wherein the PDA is in receive-only communication with the satellite terminal and can indicate to the installer when the antenna is pointed in a proper direction according to an embodiment of the present invention.

### DETAILED DESCRIPTION OF THE PREFERRED EMBODIMENTS

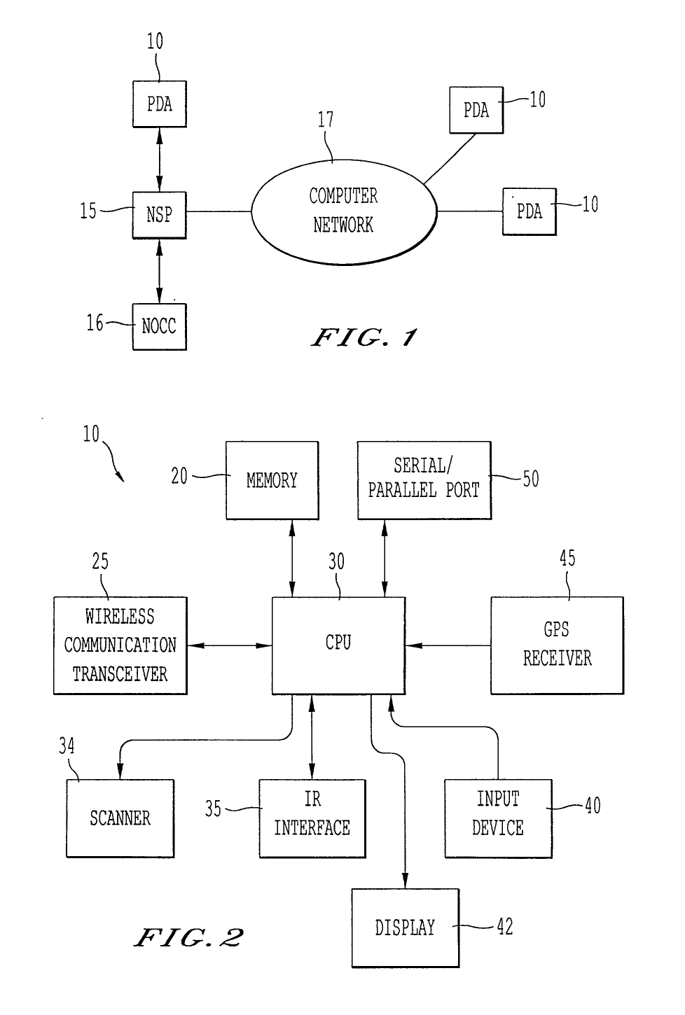

FIG. 1 illustrates a multiplicity of hand-held or portable computers such as PDAs 10 communicating with a network service provider (NSP) 15. The communication link is preferably wireless and bidirectional, but can be accomplished via a wireline link or a combination of wireline and wireless links. The communication link between the PDA 10 and the NSP 15 can be a dedicated or shared link and can be implemented via an intranet or the internet.

A plurality of PDAs 10 are illustrated in FIG. 1, as there can be several installers attempting to communicate with the network service provider 15. Information relating to one or a plurality of work orders is downloaded from the network service provider 15 to each PDA 10 via wireline or wireless communication. These work orders contain information relating to the electronic equipment to be installed and commissioned such as a satellite terminal. The information can include, but is not limited to, contact information, the customer address, a terminal site identification code corresponding to the customer premises and a service passcode, and a satellite network identification code, among other information. The terminal site identification code and the service passcode are provided to a network operations control center (NOCC) for the network of terminals by the NSP, as well as to the terminal by the PDA, so that the terminal will be able to register with the NOCC. The work order can also specify the type of electronic equipment (e.g., if different models of terminals are available) in the field that needs to be initially configured or reconfigured and brought into commission by an installer. Each PDA 10 is preferably portable and is carried by an installer to the site of each piece of electronic equipment identified in the corresponding work order as being in need of configuration and commissioning. In accordance with the present invention, the process of downloading work orders from a network service provider to the PDA 10 does not require an installer to key in any alphanumeric information on the PDA 10, nor does it require the installer to handle physical documents or write any information onto paper.

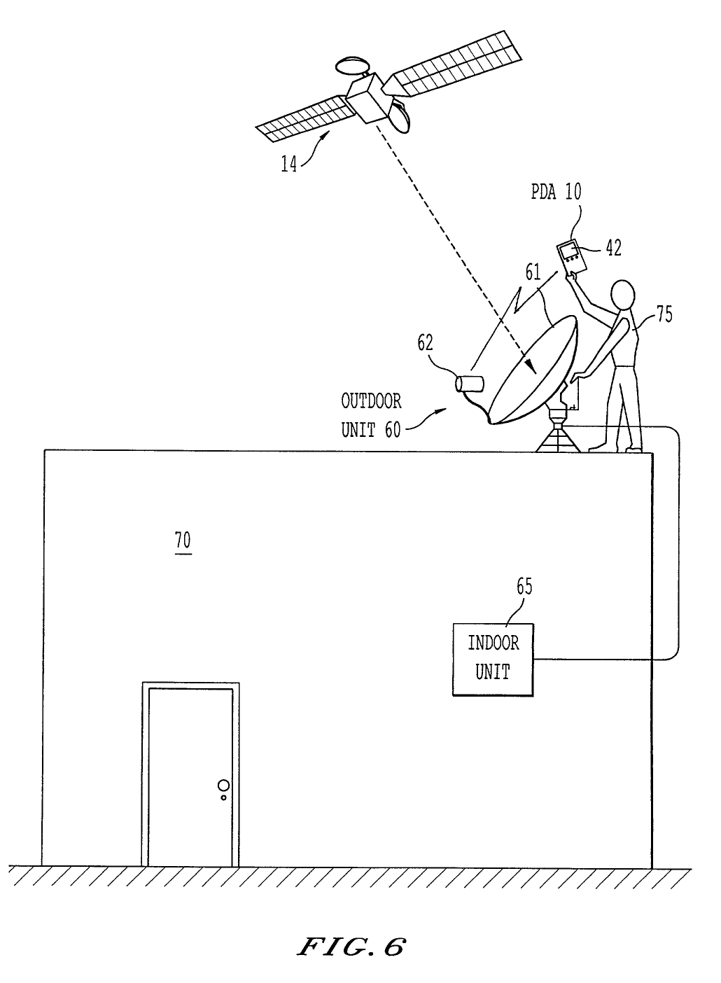

Bringing a satellite terminal into operation generally involves two phases: 1) installation of the satellite terminal; and 2) commissioning of the satellite terminal. Installation comprises assembly and placement of terminal equipment and cables, entering configuration data relating to the satellite terminal, obtaining location information, setting the polarization of the outdoor unit 20 to either left hand circular polarization or right hand circular polarization, for example, and pointing a dish on an outdoor unit 20 of a satellite terminal towards a geosynchronous satellite 14 (FIG. 6), among other operations. The geosynchronous satellite 14 provides broadcasting or other communication services and is generally a different satellite from the GPS satellites 12 described below in connection with FIG. 5. Commissioning of a satellite terminal, on the other hand, involves establishing communication between the satellite terminal and the geosynchronous satellite, other satellite terminals (i.e., depending on the type of network in which the satellite terminal is deployed), and the NOCC 16. The NOCC 16 manages customer permissions and payment processes to use the network bandwidth, that is, the extent to which each satellite terminal receives broadcast signals or exchanges data with other terminals, depending on the type of communication network in which the satellite terminal is deployed. In addition, the NOCC manages the address or location of installation of each satellite terminal in the network, serial numbers of equipment to be installed, time of installation, type of service, such as basic, premium, content preferences, and so on. The present invention is advantageous because both of these processes are achieved by an installer using a PDA 10 or other portable computer and the satellite terminal and without requiring the installer to manually input alphanumeric data into the PDA 10 or use paper documents such as a work order provided on paper.

The present invention can be employed with terminals in a one-way communication network or a two-way communication network. A one-way communication network typically involves broadcast of selected program channels. A two-way communication network can involve terminal-to-terminal communication or, for example, communication between a terminal and an internet service provider. Both one-way and two-way services can be provided from geosynchronous satellites connected to a network containing a NOCC 16. Once commissioned, satellite terminals in a two-way network can communicate with other terminals pointed toward the same satellite 14 or to satellite terminals directed to a different satellite 14 via an intersatellite gateway.

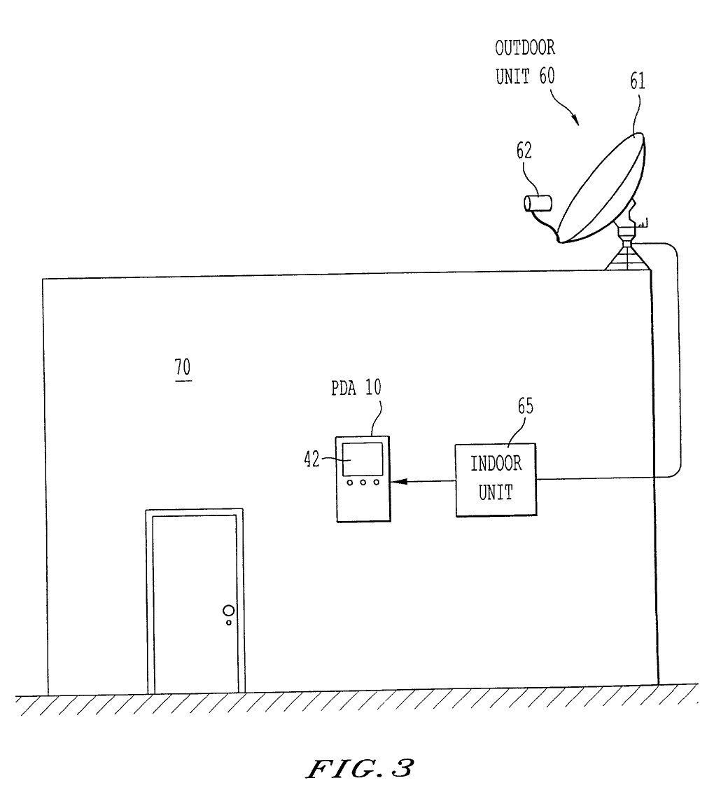

FIG. 2 illustrates an exemplary PDA 10. The PDA 10 comprises a memory 20 for storing data and commands, a wireless communication transceiver 25 that can send and receive signals from external devices such as the NSP 15, a central processing unit 30 to control the overall operation of the PDA 10, a scanner 34 and an infrared (IR) or other wireless communication interface 35 (e.g., Bluetooth signaling) to allow the PDA 10 to send and receive wireless data signals to a terminal. The scanner 34 is useful for one-way communication such as reading a bar code or receiving a radio frequency code corresponding to an indoor unit (IDU) or an outdoor unit (ODU) of a satellite terminal. The wireless communication interface 35, on the other hand, can be useful for two-way communication such as for data downloading or uploading between the PDA and the terminal.

With continued reference to FIG. 2, an input device 40 provides an operator interface that allows the installer to select from buttons or menus displayed on the PDA display 42 such as the function the installer would like the PDA 10 to perform. In addition, the PDA 10 of the present invention can include a global positioning system (GPS) satellite receiver 45 that allows the installer to determine the position of the terminal within, for example, 100 meters. It is to be understood that other position location methods can be used to determine the location of the terminal being commissioned. The PDA 10 also preferably comprises a port 50 to allow for wireline communication between the PDA 10 and an external device such as the NSP 15, the NOCC 16 or a personal computer. An installer can use menus on the display 42 to select between wireline or wireless data transmission or reception, whether global positioning is to be used, or whether the display is to display particular information regarding the status of an electronic equipment, for example. An installer can also use menus on the display to control the execution of diagnostic tests by the satellite terminal.

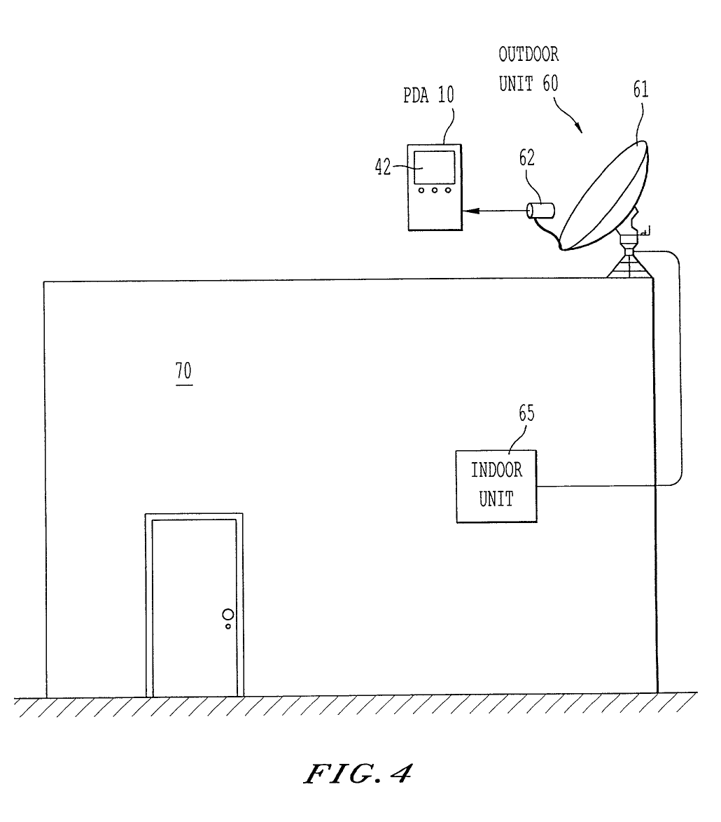

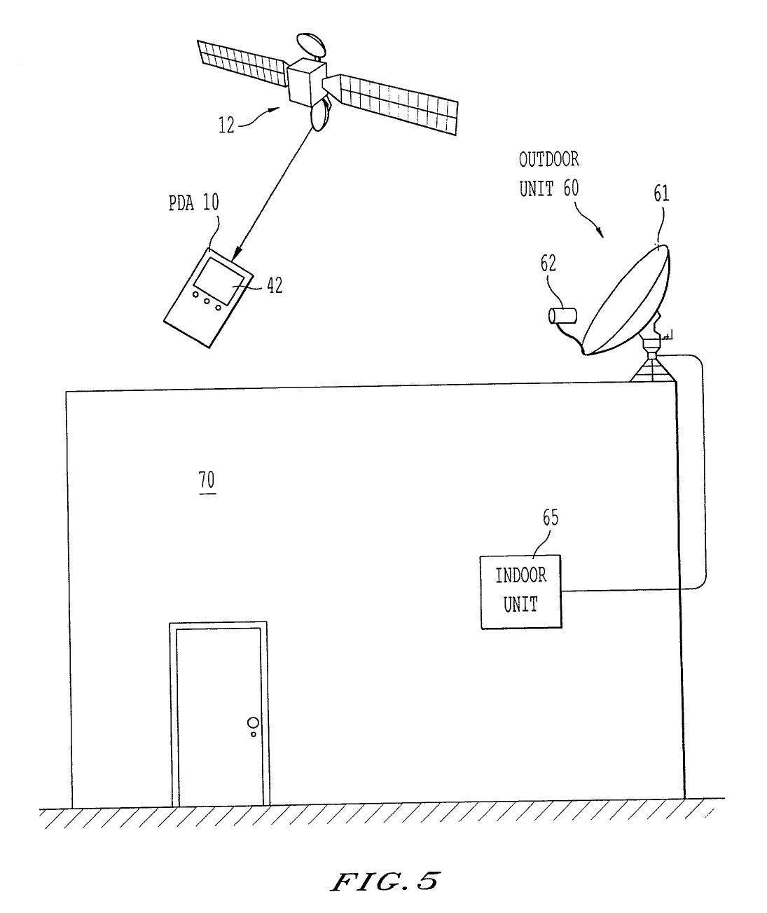

FIGS. 3 and 4 illustrate the PDA 10 scanning information provided on or by a piece of electronic equipment. The electronic equipment illustrated in FIGS. 3 and 4 is a satellite terminal. A satellite terminal comprises an outdoor unit 60 having a satellite dish 61 and a feed horn 62 that is installed, for example, on the rooftop of a building 70, and an indoor unit 65 located within the building 70. The indoor unit 65 processes signals received from the outdoor unit 60 and delivers these processed signals to electronic communication equipment (not shown) within the building 70 such as a computer, television or a telephone. FIG. 3 illustrates the PDA 10 scanning the indoor unit 65 for a barcode or other optically scanned indicia on the indoor unit 65, or receiving a radio frequency identification tag generated by the indoor unit, to notify the PDA 10 of the serial number of the electronic equipment with which the PDA is interfacing. FIG. 4 illustrates the PDA 10 scanning the outdoor unit 60 for a barcode or a radio frequency identification (RFID) tag provided by the outdoor unit to notify the PDA 10 of the serial number of the electronic equipment with which the PDA is interfacing. In a satellite terminal, the indoor unit 65 and the outdoor unit 60 are generally both scanned for identification data, since these two units are usually remotely located with respect to each other and it is possible to select and replace one independently of the other.

An installer (not shown) carries the PDA 10 to the indoor unit 65 and the outdoor unit 60 to scan for the barcode or RFID tag, for example. The present invention is advantageous because the process of scanning the equipment for a barcode or an RFID tag is accomplished without requiring the installer to manually enter this identification information into the PDA 10 and without the installer having to handle papers or write information onto papers, thus reducing the possibility of human errors, and quickening the process of configuration and commissioning.

FIG. 5 illustrates how location determination of the electronic equipment is achieved. A GPS receiver or other position determination device is provided within the PDA 10. In accordance with another embodiment of the present invention, the GPS receiver can be provided within the outdoor unit 60; however, such an arrangement prohibits an installer from moving to another location to achieve positioning if the outdoor unit 60 is situated where reception of global positioning system signals is poor. When the position determination device (e.g., the GPS receiver 45) is co-located with the PDA 10, an installer (not shown) need only to point the PDA 10 towards the sky. The GPS allows an individual on the ground to determine within approximately 100 meters where he is located by using GPS receiver 45 within the PDA 10. Generally, reception is possible from three or four satellites 12 above the horizon at any place on the earth's surface to allow the PDA to determine the position of the satellite terminal that is being configured and commissioned.

When the PDA 10 is in communication (e.g., via IR or Bluetooth signaling) with the indoor unit 65, the indoor unit 65 is programmed by the PDA 10 with the work order received from the network service provider 15 and the location information obtained via the global positioning system. In return, the indoor unit 65 sends to the PDA 10 configuration data such as polarization and pointing data needed for the installation of the satellite terminal (e.g., uplink polarization, initial pointing direction, uplink cell and downlink microcell). The installer then points the satellite dish 61 of the satellite terminal to position the dish for good reception.

FIG. 6 illustrates an installer 75 beside the outdoor unit 60 holding the PDA 10 which is in communication (e.g., via cable or wireless signaling) with the outdoor unit 60. The outdoor unit 60 is programmed to measure signal strength of signals received from satellite 14. The installer can use this data to determine how far off the dish is from optimal reception and in which direction the dish on the outdoor unit 60 must be pointed to in order to function properly with a network. For example, a voltmeter can be connected to the ODU, or the PDA 10 can be programmed with a voltmeter application, to provide an indication in volts of the measured signal strengths. The installer 75 reads the voltmeter or display device 42 of the PDA 10 while making the pointing adjustments to the outdoor unit 60 until the voltmeter or PDA 10 indicates to the installer 75 that the outdoor unit 60 is pointing in a proper direction. The dish can be moved manually or automatically. The optimal direction is the direction where the outdoor unit 60 points to a geosynchronous satellite 14 providing the desired customer service. When pointed towards the geosynchronous satellite 14, the satellite terminal can also achieve communication with the NOCC 16 and other satellite terminals, depending on the type of network in which the satellite terminal is located. In addition, prior to pointing the outdoor unit, the installer 75 sets the polarization of the outdoor unit 60 to receive either right hand circularly polarized signals or left hand circularly polarized signals.

After making the necessary adjustments to the satellite terminal, the installer generally tightens bolts on the outdoor unit 60 so that the orientation of the dish will not change after the installer leaves the work site. Since the outdoor unit 60 is pointing to a geosynchronous satellite 14 which remains essentially stationary with respect to the surface of the earth, the pointing direction of the outdoor unit 60 need not be readjusted after the installer leaves the site. The satellite terminal will, within an error range, remain correctly pointed at the geosynchronous satellite and be in communication with the network and the NOCC.

Commissioning is generally initiated after the satellite terminal is taken out of pointing mode. FIG. 3 illustrates the PDA 10 receiving data from the indoor unit 65 verifying that the adjustments to and configurations of the satellite terminal have been completed. The installer then brings into commission the satellite terminal that has just been installed by communicating with the indoor unit 65 via the PDA 10. The indoor unit 65, in turn, communicates with the NOCC 16. Data from the ST and the NOCC 16 regarding the commissioning of the newly installed satellite terminal is uploaded into the PDA 10. This commissioning data includes: 1) information downloaded from the network relating to, for example, transmit synchronization, registration, authentication, software download, login and security; 2) diagnostic information such as test results and measurements of how the newly installed satellite terminal is working; and 3) inventory information pertaining to the newly installed satellite terminal.

Although the above described process involves configuring and commissioning a single satellite terminal, the installer may then travel with the PDA 10 to configure and commission other satellite terminals before returning to the network service provider 15 since more than one work order can be downloaded to the PDA 10 via the NSP 15 and/or the NOCC 16. After completing all work orders downloaded via the network service provider 15, the PDA 10 uploads all of the information pertaining to the completion of the work orders (e.g., serial numbers, GPS information) and the commissioning data to the NSP 15. This is accomplished without requiring the installer to manually enter information such as alphanumeric data into the PDA 10. Thus, an installer need only communicate with the network service provider only twice a day, that is, once to download a number of work orders, and again to upload information pertaining to the completion of the work orders. The present invention therefore allows for more efficient communication between the installer and the NSP 15.

Although the above-described invention discusses the configuration and commissioning of satellite terminals, the above invention can also be applied to any electronic equipment to change any parameter associate therewith. In the illustrated embodiments, satellite terminals are initialized, registered, commissioned, and repaired. This invention, however, pertains to any type of adjustment to equipment located in the field.

While the preferred embodiments have been set forth with a degree of particularity, it is to be understood that changes and modifications could be made to the construction thereof which would fall within the teachings of the claimed invention as set forth in the following claims.

What is claimed is:

1. A method of bringing a satellite terminal into service, comprising the steps of:
downloading installation information from a network service provider providing data relating to the service to a portable processing device;
automatically receiving identification codes for an indoor unit and an outdoor unit of said satellite terminal via said portable processing device;
obtaining location information relating to said satellite terminal;
programming said indoor unit with said location information and said installation information;
uploading configuration data from said indoor unit into said portable processing device; and
pointing a dish on said outdoor unit to a satellite providing said service while viewing pointing information using said portable processing device, said pointing information being provided to said portable processing device by said outdoor unit.

2. The method of claim 1, further comprising the step of uploading information relating to completion of installation from said portable processing device into said network service provider.

3. The method of claim 1, further comprising the step of selecting polarization of said satellite terminal.

4. The method of claim 1, wherein said location information is obtained from a global positioning system.

5. The method of claim 4, wherein a receiver of said global positioning system is co-located with said portable pointing device.

6. The method of claim 1, wherein said identification codes comprise at least one type of information selected from the group consisting of bar coded identification data, optically scanned identification data, and radio frequency identification data.

7. The method of claim 1, wherein said method is accomplished in the absence of either writing information onto paper, and manually entering in alphanumeric data to said portable processing device.

8. The method of claim 1, wherein said portable processing device sends and receives at least one of said location information and said installation information via wireless communication.

9. The method of claim 1, wherein said portable processing device sends and receives at least one of said location information and said installation information via wireline communication links.

10. The method of claim 1, further comprising the steps of:
downloading commissioning information from said network service provider providing commissioning information related to the commissioning of said satellite terminal to said portable processing device; and
receiving commissioning data by said portable processing device from said indoor unit.

11. The method of claim 10, wherein said commissioning data comprises at least one type of information selected from the group consisting of diagnostic information regarding said configuration data of said satellite terminal, measurements describing the functioning of said satellite terminal, and inventory information regarding the location and identification of said satellite terminal.

12. The method of claim 11, further comprising the step of uploading said commissioning data from said portable processing device to said network service provider.

13. The method of claim 12, wherein said commissioning data is received by said satellite terminal from a network operations control center via said outdoor unit.

14. The method of claim 13, wherein said network service provider communicates with said network operations control center using said inventory information to confirm said satellite terminal is in its proper location and is connected to a network.

15. A method of bringing a satellite terminal into service, comprising the steps of:
downloading commissioning information from a network service provider to portable processing device;
automatically receiving identification codes for an indoor unit and an outdoor unit of said satellite terminal via said portable processing device;
obtaining commissioning data by said portable processing device from said indoor unit; and
uploading said commissioning data from said portable processing device into said network service provider.

16. The method of claim 15, wherein said commissioning data comprises at least one type of information selected from the group consisting of diagnostic information regarding said configuration data of said satellite terminal, measurements describing the functioning of said satellite terminal, and inventory information regarding the location and identification of said satellite terminal.

17. The method of claim 16, wherein said commissioning data is received from a network operations control center via said outdoor unit.

18. The method of claim 17, wherein said network service provider communicates with said network operations control center to confirm, using said inventory information, that said satellite terminal is in its proper location and is connected to a network.

19. The method of claim 15, wherein said identification codes comprise at least one type of information selected from the group consisting of bar coded identification data, optically scanned identification data, and radio frequency identification data.

20. The method of claim 15, wherein said method is accomplished in the absence of writing information onto papers, and manually entering in alphanumeric data to said portable processing device.

21. The method of claim 15, wherein said portable processing device sends and receives at least one of said commissioning information and said commissioning data via wireless communication.

22. The method of claim 15, wherein said portable processing device sends and receives at least one of said commissioning information and said commissioning data via wireline communication links.

23. The method of claim 15, further comprising the steps of:
obtaining location information relating to said satellite terminal;
programming said indoor unit with said location information and said installation information;
uploading configuration data from said indoor unit into said portable processing device; and
pointing a dish on said outdoor unit to a satellite providing said service while viewing pointing information using said portable processing device, said pointing information being provided by said outdoor unit.

24. The method of claim 23, further comprising the step of actuating a switch to set the polarization of said satellite terminal.

25. The method of claim 23, wherein said location information is obtained from a global positioning system.

26. The method of claim 25, wherein a receiver of said global positioning system is co-located with said portable processing device.

27. An apparatus for bringing into service a satellite terminal, comprising:
a processing device configured for sending and receiving information to and from electronic equipment;
a location information device configured to determine the approximate position of said processing device; and
a wireless communication interface for communicating with a remote network service provider, said network service provider being operable to provide installation information to said processing device for bringing said satellite terminal into service, wherein said satellite terminal comprises an indoor unit and an outdoor unit, said indoor unit and said outdoor unit comprising at least one type of information code selected from the group consisting of optically coded identification tags, and radio frequency identification tags, wherein said processing device is configured for wireless communication, said processing device being capable of obtaining said information codes from said indoor unit and said outdoor unit via said wireless communication.

28. The apparatus of claim 27, wherein said processing device sends and receives said information via wireline communication links.

29. The apparatus of claim 27, wherein said outdoor unit comprises a satellite dish and is operate to measure the strength of signals received from a satellite to which the dish is directed, said apparatus further comprising a display device connected to said processing device, said processing device being operable to receive data from said satellite terminal relating to the strength of said received signals and to generate screens on said display device that indicate how to point said dish for optimal reception via said satellite.

30. The apparatus of claim 29, wherein said processing device receives updates of said data from said satellite terminal while said dish is being moved and pointed, said processing device being programmable to update said screens.

31. The apparatus of claim 27, wherein said apparatus is portable.

32. The apparatus of claim 31, wherein said location information device is a global positioning system receiver and said apparatus can be carried and pointed to global positioning system satellites during installation of said satellite terminal.
